(19) United States
(12) Patent Application Publication
(10) Pub. No.: US 2015/0193945 A1
(43) Pub. Date: Jul. 9, 2015

(54) METHOD AND APPARATUS FOR GENERATING DANCE MOTION BASED ON POSE AND TIMING CONSTRAINTS

(71) Applicant: Electronics and Telecommunications Research Institute, Daejeon (KR)

(72) Inventors: Seong-Min BAEK, Daejeon (KR); Myung-Gyu KIM, Daejeon (KR); Ye-Jin KIM, Daejeon (KR); Jong-Sung KIM, Daejeon (KR); Il-Kwon JEONG, Daejeon (KR)

(21) Appl. No.: 14/581,939

(22) Filed: Dec. 23, 2014

(30) Foreign Application Priority Data
Jan. 7, 2014 (KR) 10-2014-0002043

(51) Int. Cl. G06T 7/20; G06F 3/01; G06T 13/80

(52) U.S. Cl. CPC G06T 7/20; G06T 13/80; G06F 3/011; G06T 2207/30196

(57) ABSTRACT

The present invention relates to a method and apparatus for generating dance motion based on pose and timing constraints. A method and apparatus for generating dance motion based on pose and timing constraints according to an embodiment of the present invention can, when a user assigns pose to the music for authoring dance choreography, search poses including the most similar pose and select poses having high connectivity to naturally connect them.

### CROSS REFERENCE TO RELATED APPLICATION

This application claims the benefit of Korean Patent Application No. 10-2014-0002043, filed on Jan. 7, 2014, entitled “Method and apparatus for generating dance motion based on pose and timing constraints”, which is hereby incorporated by reference in its entirety into this application.

### BACKGROUND

1. Technical Field

The present invention relates to a method and apparatus for generating dance motion based on pose and timing constraints.

2. Background Art

There are several methods for editing and interpolating motion by using a computer. However, most of them are based on locomotion such as walking, running and the like. Studies on generating dynamic dance motions which are assigned motions to the music are still required. Even though there have been studies on generating motions to the rhythm (beat) of music, these are simply intended to synchronize the music and motions, not to generate desired motions at a given time. A method for generating motion using motion interpolation has been introduced. The method using a key-frame in order to synchronize the music and motions and generate exact motions. However, quality resulted therefrom is still low and it requires to use lots of keys. Therefore, there is a large demand for resolving such problems.

### SUMMARY

Embodiments of the present invention provide a method and apparatus for generating dance motion based on pose and timing constraints which can, when a user assigns pose to the music for authoring dance choreography, search poses including the most similar pose and select poses having high connectivity to naturally connect them.

Embodiments of the present invention provide a method and apparatus for generating dance motion based on pose and timing constraints which can generate dance motions having high quality from the least pose data.

Embodiments of the present invention provide a method and apparatus for generating dance motion based on pose and timing constraints which can, when a user learns dancing, be applied to interactive dance learning to compare with professional's poses and teach.

An embodiment of the present invention may provide an apparatus for generating dance motion based on timing and pose constraints comprising: a pose data receiving part configured to receive at least one pose data and time information corresponding to each of the plurality of the pose data from a user; a similar pose candidate data searching part configured to determine a similar difference value between the received pose data and each pose of the plurality of motion data stored in motion database and select similar pose data of which the similar difference value is equal to or less than a threshold as similar pose candidate data; a motion clip generating part configured to acquire motion clip candidates, which including pose similar to the received pose data, from the similar pose candidate data based on timing constraints according to the time information; a connectable motion clip selecting part configured to calculate direction and speed similarity, and relationship similarity of the previous motion clip and the motion clip candidates, calculate the final similarity by providing constant weight values to the similar difference value, the direction and speed similarity and the relationship similarity, and select the connectable motion clip of which the final similarities are equal to or less than a threshold; and a motion clip connecting part configured to arrange the selected connectable motion clips in motion connecting blocks, estimate positions of joints of the next connectable motion clip by controlling position of root joint of the next connectable motion clip, and connect the next connectable motion clip by calculating joint angles from the estimated positions of joints.

In an embodiment, the similar pose candidate data searching part may comprise: a root joint position comparing part configured to generate a difference value (H) according to height represented by the following Equation 1 based on the received pose data and each of the plurality of pose data stored in the motion database; a joint pose vector comparing part configured to generate a difference value (\check{V}) according to pose vector represented by the following Equation 2 based on the received pose data and each of the plurality of pose data stored in the motion database; and a similarity calculating part configured to calculate a similar difference value (\check{P}(Fᵢ,Fⱼ) represented by the following Equation 3 based on the difference value (\check{H}) according to height and the difference value (\check{V}) according to pose vector and select the similar pose data, of which the similar difference value is equal to or less than a threshold, as similar pose candidate,

$$\begin{matrix}{H}^{} = {( {Ry}_{i} - {Ry}_{j} )}^{2} & Equation 1 \\ {V}^{} = {\sum }_{k} {ω}_{k} \cdot ( {a}_{1} \cdot {cos}^{- 1} ( {pv}_{i , k} \cdot {pv}_{j , k} ) + {a}_{2} \cdot ( {v}_{i , k} - {v}_{j , k} ) ) & Equation 2 \\ {P}^{} ( {F}_{i} , {F}_{j} ) = {α}_{1} \cdot {H}^{} + {α}_{2} \cdot {V}^{} & Equation 3\end{matrix}$$

wherein \check{H} is a difference value according to height, \check{V} is a difference value according to pose vector, Ryᵢ is y-axis position of the root joint, pv_{i,k} is the kth pose vector at the ith frame, α₁,α₂ are importance parameters, ωₖ is importance

$$( {\sum }_{k} {ω}_{k} = 1 )$$

of joint, a₁,a₂ are scale values to control angle difference and length difference of pose vector.

In another embodiment, the connectable motion clip selecting part may comprise: a moving vector identifying part configured to identify if a moving vector of current motion clip fits with a moving vector of one of motion clip candidates by calculating the direction and speed similarity (\check{D}) represented by the following Equation 4 based on the previous motion clip and the motion clip candidates; a relationship similarity calculating part configured to convert the positions of the joints of the previous motion clip to a function (\check{f}(xᵢ)) by using the least squares approximation and calculate relationship similarity (\check{C}) represented by the following Equation 3 based on the function (\check{f}(xᵢ)) and positions (pᵢ) of the joints of the one of motion clip candidates; and a connectable motion clip obtaining part configured to provide constant weight values to the similar difference value (\check{P}), the direction and speed similarity (\check{D}), the relationship similarity (\check{C}) and obtain the connectable motion clip of which the final similarities (M) represented by the following Equation 6 are equal to or less than a threshold,

\check{D}=C₁·COS⁻¹(V_{(i-1,i)}·V_{(j,j+1)})+C₂·(V_{(i-1,i)}−V_{(j,j+1)}) Equation 4

wherein, vector V_{(i-1,i)} is velocity vector by the position of the root joint in i−1th frame and ith frame of previous motion clip, vector V(j, j+1) is velocity vector of following motion clip candidate, C₁,C₂ are scale values to match units of angle and length,

$$\begin{matrix}{C}^{} = {\sum }_{i = 1}^{n} {[ \hat{f} ( {x}_{i} ) - {p}_{i} ]}^{2} & Equation 5 \\ M = {μ}_{1} \cdot {P}^{} + {μ}_{2} \cdot {D}^{} + {μ}_{3} \cdot {C}^{} & Equation 6\end{matrix}$$

wherein μ₁,μ₂,μ₃ are weight values.

In still another embodiment, the motion clip connecting part may comprise: a similar pose searching part configured to search the similar pose which can be connected in the motion connecting blocks; a time warping part configured to arrange the connectable motion clips in the motion connecting blocks and perform time warping for empty or overlapping motion connecting blocks among the motion connecting blocks; a position estimating part configured to control position of root joint of the next connectable motion clip arranged in the motion connecting blocks and estimate positions of joints of the next connectable motion clip by using the Ferguson curve; a joint angle calculating part configured to calculate joint angles from the estimated positions of joints; and a character applying part configured to apply the joint angles to a character.

Another embodiment of the present invention may provide a method for generating dance motion based on timing and pose constraints comprising: receiving at least one pose data and time information corresponding to each of the plurality of the pose data from a user; determining a similar difference value between the received pose data and each pose of the plurality of motion data stored in motion database and selecting similar pose data of which the similar difference value is equal to or less than a threshold as similar pose candidate data; acquiring motion clip candidates, which including pose similar to the received pose data, from the similar pose candidate based on timing constraints according to the time information; calculating direction and speed similarity and relationship similarity of the previous motion clip and the motion clip candidates, calculating the final similarity by providing constant weight values to the similar difference value, the direction and speed similarity and the relationship similarity, and selecting connectable motion clip of which the final similarities are equal to or less than a threshold; and arranging the connectable motion clips in motion connecting blocks, estimating positions of joints of the next connectable motion clip by controlling position of root joint of the next connectable motion clip, and connecting the next connectable motion clip by calculating joint angles from the estimated positions of joints.

In an embodiment, the searching similar pose data as similar pose candidate data may comprise: generating a difference value (\check{H}) according to height represented by the following Equation 1 based on the received pose data and each of the plurality of pose data stored in the motion database; generating a difference value (\check{V}) according to pose vector represented by the following Equation 2 based on the received pose data and each of the plurality of pose data stored in the motion database; and calculating a similar difference value (\check{P}(Fⱼ,Fⱼ)) represented by the following Equation 3 based on the difference value (\check{H}) according to height and the difference value (\check{V}) according to pose vector and selecting the similar pose data, of which the similar difference value is equal to or less than a threshold, as similar pose candidate,

$$\begin{matrix}{H}^{} = {( {Ry}_{i} - {Ry}_{j} )}^{2} & Equation 1 \\ {V}^{} = {\sum }_{k} {ω}_{k} \cdot ( {a}_{1} \cdot {cos}^{- 1} ( {pv}_{i , k} \cdot {pv}_{j , k} ) + {a}_{2} \cdot ( {v}_{i , k} - {v}_{j , k} ) ) & Equation 2 \\ {P}^{} ( {F}_{i} , {F}_{j} ) = {α}_{1} \cdot {H}^{} + {α}_{2} \cdot {V}^{} & Equation 3\end{matrix}$$

wherein \check{H} is a difference value according to height, \check{V} is a difference value according to pose vector, Ryᵢ is y-axis position of the root joint, pv_{i,k} is the kth pose vector at the ith frame, α₁,α₂ importance parameters, ωₖ is importance

$$( {\sum }_{k} {ω}_{k} = 1 )$$

of joint, a₁,a₂ are scale values to control angle difference and length difference of pose vector.

In another embodiment, the selecting the connectable motion clips may comprise: identifying if a moving vector of current motion clip fits with a moving vector of one of motion clip candidates by calculating the direction and speed similarity (\check{D}) represented by the following Equation 4 based on the previous motion clip and the motion clip candidates; converting the positions of the joints of the previous motion clip to a function (\check{f}(xᵢ)) by using the least squares approximation and calculating relationship similarity (\check{C}) represented by the following Equation 5 based on the function (\check{f}(xᵢ)) and positions (pᵢ) of the joints of the one of motion clip candidates; and providing constant weight values to the similar difference value (\check{P}), the direction and speed similarity (\check{D}), the relationship similarity (\check{C}) and obtaining the connectable motion clip of which the final similarities (M) represented by the following Equation 6 are equal to or less than a threshold,

\check{D}=C₁·COS⁻¹(V_{(i-1,i)}·V_{(j,j+1)})+C₂·(V_{(i-1,i)}−V_{(j,j+1)}) Equation 4

wherein, vector V_{(i-1,i)} is velocity vector by the position of the root joint in i−1th frame and ith frame of previous motion clip, vector V(j, j+1) is velocity vector of following motion clip candidate, C₁, C₂ are scale values to match units of angle and length,

$$\begin{matrix}{C}^{} = {\sum }_{i = 1}^{n} {[ \hat{f} ( {x}_{i} ) - {p}_{i} ]}^{2} & Equation 5 \\ M = {μ}_{1} \cdot {P}^{} + {μ}_{2} \cdot {D}^{} + {μ}_{3} \cdot {C}^{} & Equation 6\end{matrix}$$

wherein μ₁,μ₂,μ₃ are weight values.

In still another embodiment, the connecting the next connectable motion clip may comprise: searching the similar pose which can be connected in the motion connecting blocks; arranging the connectable motion clips in the motion connecting blocks and performing time warping for empty or overlapping motion connecting blocks among the motion connecting blocks; controlling position of root joint of the next connectable motion clip arranged in the motion connecting blocks and estimating positions of joints of the next connectable motion clip by using the Ferguson curve; calculating joint angles from the estimated positions of joints; and applying the joint angles to a character.

A method and apparatus for generating dance motion based on pose and timing constraints according to an embodiment of the present invention can, when a user assigns pose to the music for authoring dance choreography, search poses including the most similar pose and select motion clip having high connectivity to naturally connect them.

A method and apparatus for generating dance motion based on pose and timing constraints according to another embodiment of the present invention can generate dance motions having high quality from the least pose data.

A method and apparatus for generating dance motion based on pose and timing constraints according to another embodiment of the present invention can be applied to interactive dance learning to compare with professional's poses and teach when a user learns dancing.

### BRIEF DESCRIPTION OF DRAWINGS

FIG. 1 shows internal configuration of an apparatus for generating dance motion based on timing and pose constraints according to an embodiment of the present invention.

FIG. 2 shows internal configuration of a similar pose candidate data searching part of an apparatus for generating dance motion based on timing and pose constraints according to an embodiment of the present invention.

FIG. 3 shows an example of pose vectors according to an embodiment of the present invention.

FIG. 4 shows an example of pose vectors at a global coordinate system and a local coordinate system according to an embodiment of the present invention.

FIG. 5 shows internal configuration of a motion clip generating part of an apparatus for generating dance motion based on timing and pose constraints according to an embodiment of the present invention.

FIG. 6 shows internal configuration of a similar motion clip selecting part of an apparatus for generating dance motion based on timing and pose constraints according to an embodiment of the present invention.

FIG. 7 shows an example of comparing joints and a function according to an embodiment of the present invention.

FIG. 8 shows internal configuration of a motion clip connecting part of an apparatus for generating dance motion based on timing and pose constraints according to an embodiment of the present invention.

FIG. 9 shows a method for arranging selected motion clips according to an embodiment of the present invention.

FIG. 10 shows an example when a sudden direction change is caused after framing.

FIG. 11 is a flowchart showing a method for generating dance motion based on pose and timing constraints according to an embodiment of the present invention.

### DESCRIPTION OF THE EXEMPLARY EMBODIMENTS

The present invention will be described with reference to particular embodiments. It is to be appreciated that various changes and modifications may be made by those skilled in the art without departing from the spirit and scope of the present invention, as defined by the appended claims and their equivalents. Even though terms used in the present invention are selected from the terms which are the most widely used today with considering functions in the present invention, they can be changed according to intention of a person who is skilled in the art, practice, or emergence of new technology. In addition, some terms are selected by an applicant and those terms will be defined in the detailed description of the present invention. Therefore, it is to be appreciated that the terms used in the present invention may be interpreted based on actual meanings thereof and the description of the present invention.

Exemplary embodiments of the present invention will be described in detail with reference to the accompanying drawings.

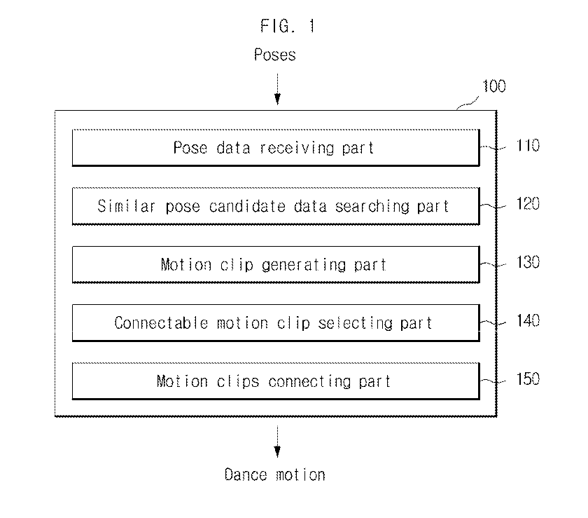

FIG. 1 shows internal configuration of an apparatus for generating dance motion based on timing and pose constraints according to an embodiment of the present invention.

Referring to FIG. 1, the apparatus 100 for generating dance motion based on timing and pose constraints according to an embodiment of the present invention may include a pose data receiving part 110, a similar pose candidate data searching part 120, a motion clip generating part 130, a connectable motion clip selecting part 140 and a motion clips connecting part 150.

The pose data receiving part 110 may receive at least one pose data and time information corresponding to each of the plurality of pose data from a user.

The similar pose candidate data searching part 120 may determine a similar difference value between the received pose data and each of a plurality of pose data stored in motion database, and select similar pose data, of which the similar difference value is equal to or less than a threshold, as similar pose candidate data.

The motion clip generating part 130 may determine motion clip candidates, which including pose similar to the received pose data, from the similar pose candidate data based on at least one of timing constraints according to the time information and frame length constraints of the plurality of pose data stored in the motion database.

The connectable motion clip selecting part 140 may calculate direction and speed similarity and relationship similarity of the previous motion clip and the motion clip candidates, calculate the final similarity by providing constant weight values to the similar difference value, the direction and speed similarity and the relationship similarity, and select connectable motion clip of which the final similarities are equal to or less than a threshold.

The motion clips connecting part 150 may arrange the selected connectable motion clips in motion connecting blocks, estimate positions of joints of the next connectable motion clip by controlling the position of root joint of the next connectable motion clip arranged in the motion connecting blocks, and connect the next connectable motion clip by calculating joint angles from the estimated positions of joints that is calculated by interpolation curve (i.e., Ferguson curve).

The apparatus for generating dance motion based on timing and pose constraints according to an embodiment of the present invention may allow, when a user assigns pose to the music for authoring dance choreography, searching poses including the most similar pose and selecting connectable motion clip having high connectivity to naturally connect them, generating dance motions having high quality from the least pose data, and being applied to interactive dance learning to compare with professional's poses and teach when a user learns dancing.

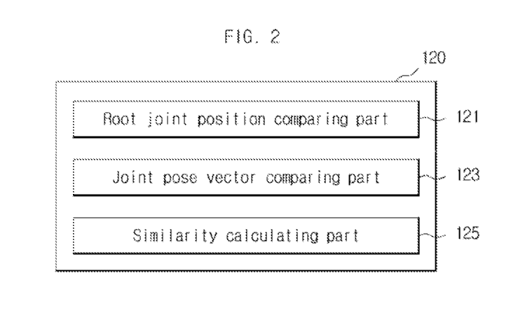

FIG. 2 shows internal configuration of a similar pose candidate data searching part of an apparatus for generating dance motion based on timing and pose constraints according to an embodiment of the present invention.

Referring to FIG. 2, the similar pose candidate data searching part according to an embodiment of the present invention may include a root joint position comparing part 121, a joint pose vector comparing part 123 and a similarity calculating part 125.

The root joint position comparing part 121 may generate a difference value (\check{H}) according to height represented by the following Equation 1 based on the received pose data and each of the plurality of pose data stored in the motion database,

\check{H}=(Ryᵢ−Ryⱼ)² Equation 1

wherein \check{H} is a difference value according to height, Ryᵢ is y-axis position of the root joint. The root joint position comparing part 121 may compare y-axis position of the root joint to find similar pose data which is similar to the received pose data. Since dance motions are more dynamic movements compared to locomotion (such as walking, running poses), those motions can be distinguished according to height in some extents.

The joint pose vector comparing part 123 may generate a difference value (\check{V}) according to pose vector represented by the following Equation 2 based on the received pose data and each of the plurality of pose data stored in the motion database,

$${V}^{} = {\sum }_{k} {ω}_{k} \cdot ( {a}_{1} \cdot {cos}^{- 1} ( {pv}_{i , k} \cdot {pv}_{j , k} ) + {a}_{2} \cdot ( {v}_{i , k} - {v}_{j , k} ) ) \qquad Equation 2$$

wherein, \check{V} is a difference value according to pose vector, pV_{i,k} is the kth pose vector at the ith frame, α₁,α₂ are importance parameters, ωₖ is importance

$$( {\sum }_{k} {ω}_{k} = 1 )$$

of joint, a₁,a₂ are scale values to control angle difference and length difference of pose vector.

Pose has a higher importance than accuracy of joint position at a global coordinate system. The apparatus for generating dance motion according to an embodiment of the present invention may thus use a method for comparing pose vectors to compare poses. Here, the pose vector means a vector from a reference joint to an end joint.

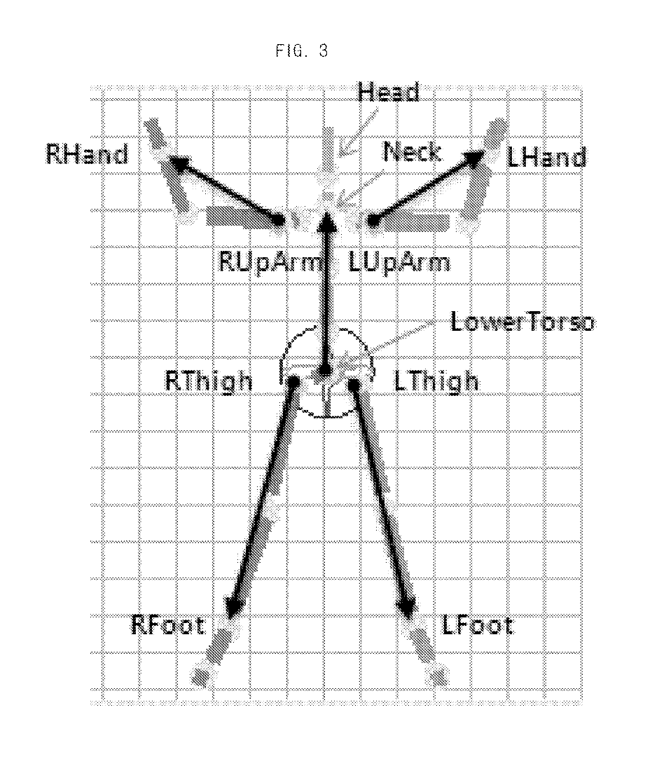

FIG. 3 shows an example of pose vectors according to an embodiment of the present invention.

Referring to FIG. 3, the pose vector may include a vector from a shoulder joint to a wrist joint, a vector from a hip joint to an ankle joint, a vector from a central joint to a neck joint, and a vector from a neck joint to a head joint. Positions of joints are compared in order to compare motions earlier at a global coordinate system. However, in the present invention, pose vectors are compared at local coordinate systems instead of at the global coordinate system so that it is not necessary to match directions and positions. Thus, an embodiment of the present invention can be suitable for interactive learnings.

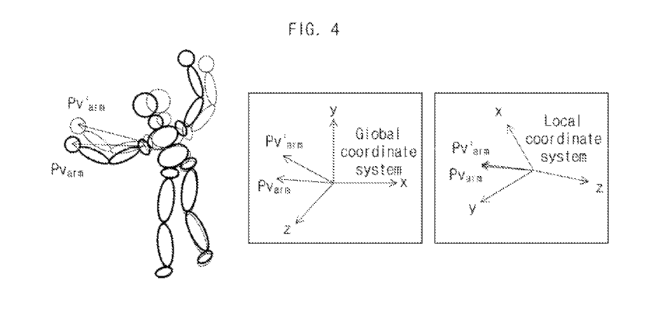

FIG. 4 shows an example of pose vectors at a global coordinate system and a local coordinate system according to an embodiment of the present invention. Referring to FIG. 4, for example, when a waist joint is slightly twisted, position errors of all joints below the waist joint are caused in the global coordinate system, while only the waist joint part has difference but positions of arms are the same in the local coordinate system. Thus, when a user learns motions of a professional's, it is easy to compare and correct motions.

The similarity calculating part 125 may calculate a similar difference value (\check{P}(Fᵢ,Fⱼ)) represented by the following Equation 3 based on the difference value (\check{H}) according to height and the difference value (\check{V}) according to pose vector, and select the similar pose data, of which the similar difference value is equal to or less than a threshold, as similar pose candidate data,

\check{P}(Fᵢ,Fⱼ)=α₁·\check{H}+α₂·\check{V} Equation 3

wherein α₁,α₂ are importance parameters.

In an embodiment, when the value calculated by the Equation 3 is the least, it means that it is the most similar pose to the received pose data. In addition, the user may set a threshold to select similar pose candidate data and the similar pose candidate data may be more than one.

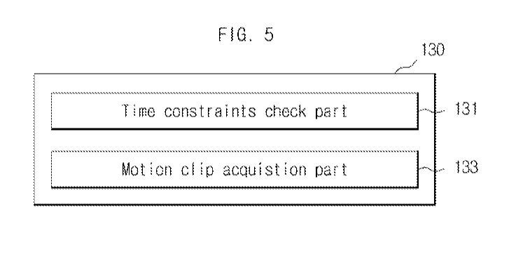

FIG. 5 shows internal configuration of a motion clip generating part of an apparatus for generating dance motion based on timing and pose constraints according to an embodiment of the present invention.

Referring to FIG. 5, the motion clip generating part according to an embodiment of the present invention may include a time constraint check part 131 and motion clip acquisition part 133.

The time constraint check part 131 may check time information corresponding to each of the received pose data.

The motion clip acquisition part 133 may acquire the motion clip candidates from the similar pose candidate data based on at least one of timing constraints according to the time information and frame length constraints of the plurality of pose data stored in the motion database.

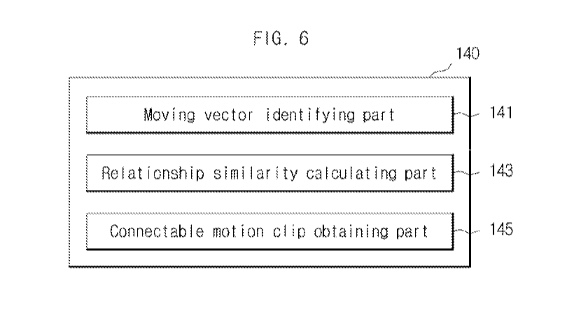

FIG. 6 shows internal configuration of a connectable motion selecting part of an apparatus for generating dance motion based on timing and pose constraints according to an embodiment of the present invention.

Referring to FIG. 6, the connectable motion clip selecting part 140 according to an embodiment of the present invention may include a moving vector identifying part 141, a relationship similarity calculating part 143 and a connectable motion clip obtaining part 145.

The moving vector identifying part 141 may identify if a moving vector of the previous motion clip fits with a moving vector of the motion clip candidates by calculating the direction and speed similarity (\check{D}) represented by the following Equation 4 based on the previous motion clip and the motion clip candidates,

\check{D}=C₁·COS⁻¹(V_{(i-1,i)}·V_{(j,j+1)})+C₂·(V_{(i-1,i)}−V_{(j,j+1)}) Equation 4

wherein, vector V_{(i-1,i)} is velocity vector by the position of the root joint in i−1th frame and ith frame of current motion clip, vector V(j, j+1) is velocity vector of following motion candidate clip, and C₁,C₂ are scale values to match units of angle and length.

When similar motion clip candidate group including similar pose is created through motion comparison, it determines if it has relationship similarity with the previous motion clip. For example, when it is assumed that new motion clip (B) is to be connected after the ith frame of the current motion clip (A), it determines if the vector moving from the i−1th frame to the ith frame is in the same moving direction with the vector moving from the jth frame of the motion clip (B) to the j+1th frame. For example, if the current motion clip (A) is the motion of lifting one arm, there is good connectivity when the next motion clip (B) also moves to the direction of lifting the arm. On the other hand, the connectivity becomes deteriorated when it moves to the opposite direction. This can be represented by the Equation 4.

The relationship similarity calculating part 143 may convert the positions of the joints of the previous motion clip to a function (\check{f}(xᵢ)) by using the least squares approximation and calculate relationship similarity (\check{C}) represented by the following Equation 5 based on the function (\check{f}(xᵢ)) and positions (pᵢ) of the joints of the motion clip candidates.

$${C}^{} = {\sum }_{i = 1}^{n} {[ \hat{f} ( {x}_{i} ) - {p}_{i} ]}^{2} \qquad Equation 5$$

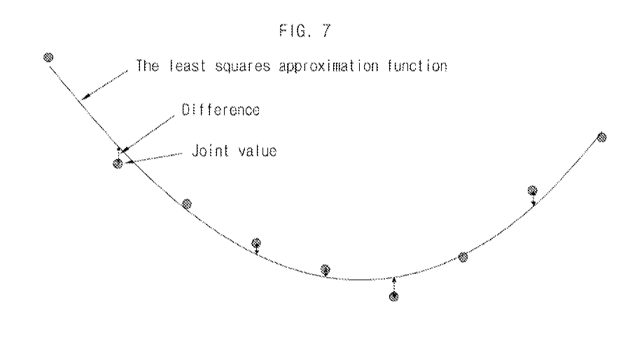

Even though the direction is similar, motions which ensure maximum connectivity should be selected for natural connection. For this, a position of an end-effector such as wrist, ankle, head and the like is converted to a function (\check{f}(xᵢ)) in a connecting block by applying the polynomial (e.g., 3rd-order polynomial) least squares approximation and the difference between the function and the joint position (pᵢ) is calculated. Since a joint position of the previous motion clip is the 3rd-order function, when the motion of which difference is the least is selected, the most connectivity can be obtained in the connecting block. FIG. 7 shows an example of comparing joints and a function according to an embodiment of the present invention.

When the motion of which values of Equation 4 and Equation 5 are the least is selected, it can be the motion which has high relationship similarity. However, the case that any motion satisfying pose constraints and having high relationship similarity is not found may occur and this may be a factor of lowering quality. Thus, the user may provide weight values to pose similarity and relationship similarity to determine that.

The connectable motion clip obtaining part 145 may provide constant weight values to the similar difference value (\check{P}), the direction and speed similarity (\check{D}), the relationship similarity (\check{C}) and obtain connectable motion clip with the final similarities (M) represented by the following Equation 6 are equal to or less than a threshold,

M=μ₁·\check{P}+μ₂·\check{D}+μ₃·\check{C} Equation 6

wherein μ₁,μ₂,μ₃ are weight values.

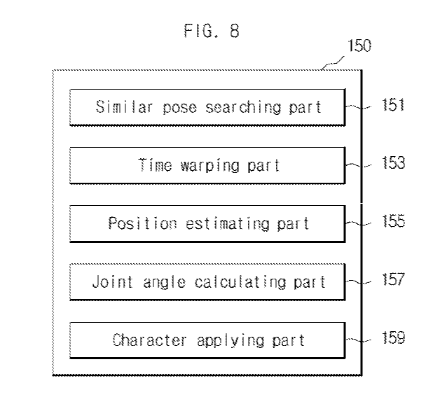

FIG. 8 shows internal configuration of motion clips connecting part of an apparatus for generating dance motion based on timing and pose constraints according to an embodiment of the present invention.

Referring to FIG. 8, motion clips connecting part 150 according to an embodiment of the present invention may include a similar pose searching part 151, a time warping part 153, a position estimating part 155, a joint angle calculating part 157, and a character applying part 159.

The similar pose searching part 151 may search similar pose between two motion clips which can be connected in the motion connecting blocks.

The time warping part 153 may arrange the frames of motion clips in the motion connecting blocks and perform time warping for empty or overlapping motion connecting blocks among the motion connecting blocks.

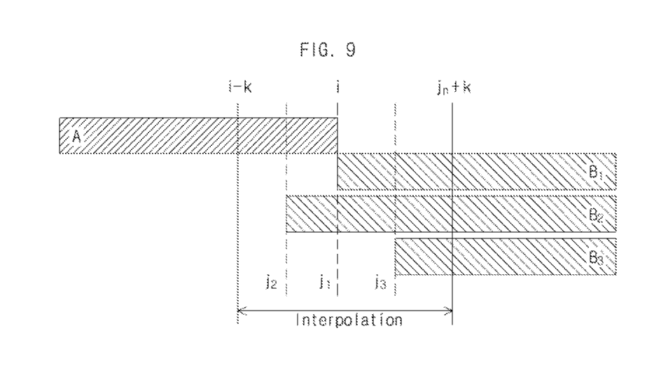

FIG. 9 shows a method for arranging the frames of selected motion clips according to an embodiment of the present invention.

Referring to FIG. 9, when the frames of motion clips are arranged in the motion connecting blocks based on the position assigned by a user, it may be one of the following 3 types (B₁, B₂, B₃). First (B₁), when the beginning of next motion clip is connected to the end of previous motion clip, a motion connection method is applied. Second (B₂), a part of motion clips can be overlapped in the motion connecting block. Third (B₃), an empty space between motion clips may be caused. When motion blocks are overlapped or empty, and motion transition is immediately performed by a motion blending method, awkward motion clips can be obtained in the connecting blocks even though motion clips are selected by considering the relationship similarity.

Therefore, the best match pose is found by using the above-mentioned similar motion comparison in the motion connecting blocks for the most natural connections. For example, when the pose in a (i-s₁) frame (s₁>k) of motion clip (A) is similar to that in (j+s₂) frame (s₂<k) of motion clip (B) (wherein k is a connecting block range) and s₁>0 & s₂>0, it causes an empty space between the connecting blocks, while when sᵢ<0 & s₂<0, it causes overlapping between the connecting blocks. If s₁=0 & s₂=0, the end frame of motion clip (A) is connected to the front frame of motion clip (B) and motion transition is applied. When motion connecting blocks are empty or overlapped, time warping is performed to adjust the blocks. The time warping is performed based on the position where foot constraints (e.g., feet are touched on the ground) exists or the position which is specified in the previous pose. When the number of frames which require time warping for large space between the connecting blocks is higher than a predetermined number, since it can cause problems in generating motions, it may inform to a user to input a new pose therebetween.

The position estimating part 155 may control position of root joint of the next connectable motion clip arranged in the motion connecting blocks and estimate positions of joints of the next similar motion clip by using the Ferguson curve.

The Ferguson curve is one of interpolation curves and determined by time, position and derivatives. Since the curve can be defined by motion time, joint position and joint velocity at a motion interpolation block, it can be suitable for the motion transition method.

Positions and directions of root joints of motions to be connected are controlled for motion connection,

P′ₙₑₓₜ=T_{θ,x}_{₀}_{,z}_{₀}Pₙₑₓₜ+V

wherein matrix T is a linear transformation that rotates by θ about Y-axis and moves on XZ-axis. When it is assumed that a movement direction is not suddenly changed because a motion frame is short, a rotation angle (θ) can be calculated from the inner product of the vector obtained from the last 2 frames (i-s₁-1, i-s₁) of motion clip (A) and the vector obtained from the first 2 frames (j+s₂, j+s₂+1) of motion clip (B). Root joint position can be estimated by direction and velocity of root joint at the beginning and the end of a motion connecting block. This can be obtained by Spline interpolation and can estimate next position from the current position by the interpolation using direction and velocity at the i-kth frame (the beginning of a connecting block) and the j+kth frame (the end of a connecting block).

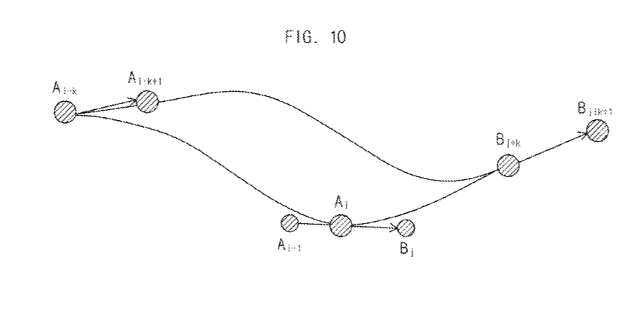

When the root joint position is determined, a Ferguson curve is generated with parameters of joint position and velocity at the i-kth, the ith, and the j+kth poses. Input of the position at the ith frame in the middle is to obtain more accurate interpolation result. For example, as shown in FIG. 10, when a direction is suddenly changed after the ith frame and there is no input for the ith frame, exact motion cannot be obtained.

The joint angle calculating part 157 may calculate a joint angle based on the estimated positions of joints. After obtaining the joint position by the Ferguson curve, joint angles are calculated from the obtained joint positions and then applied to a character. Since when the calculated joint position value is directly used, a length between joints can be changed, it is important to convert the joint position to the joint angle. Here, in case of feet, when constraints with the ground is not satisfied, feet slide can be solved by using inverse kinematic (IK) technique.

The character applying part 159 may apply the joint angle to a character.

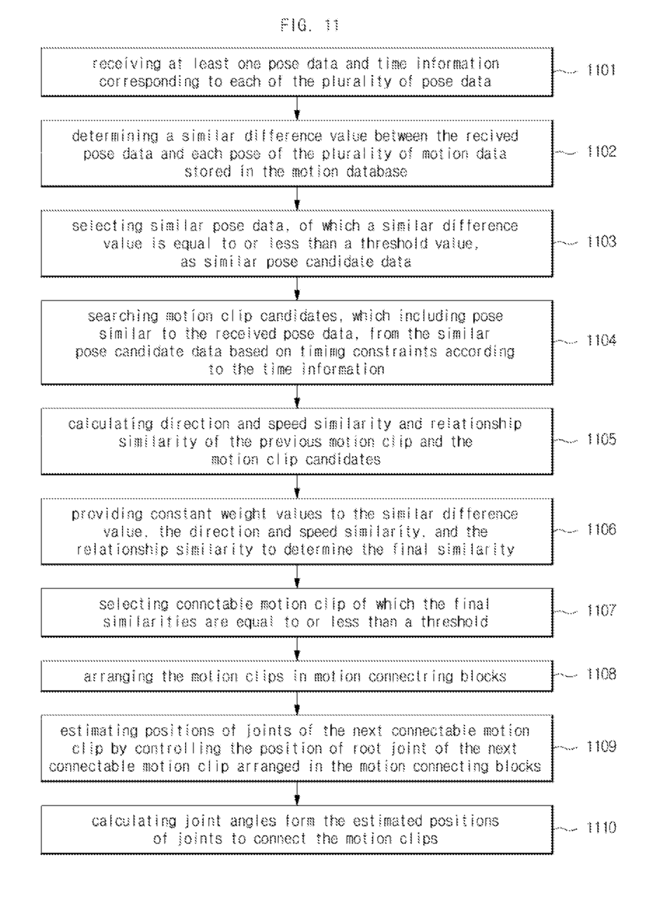

FIG. 11 is a flowchart showing a method for generating dance motion based on pose and timing constraints according to an embodiment of the present invention.

Referring to FIG. 11, in 1101, at least one pose data and time information corresponding to each of the plurality of pose data may be received from a user.

In 1102, a similar difference value between the received pose data and each pose of the plurality of motion data stored in the motion database may be determined.

In 1103, similar pose data, of which a similar difference value is equal to or less than a threshold value, may be selected as similar pose candidate data.

In S1104, motion clip candidates, which including pose similar to the received pose data, may be determined from the similar pose candidate data based on timing constraints according to the time information.

In 1105, direction and speed similarity and relationship similarity of the previous motion clip and the motion clip candidates may be calculated.

In 1106, constant weight values may be provided to the similar difference value, the direction and speed similarity, and the relationship similarity to determine the final similarity.

In 1107, connectable motion clips of which the final similarities are equal to or less than a threshold may be selected.

In 1108, the connectable motion clips may be arranged in motion connecting blocks.

In 1109, positions of joints of the next connectable motion clip may be estimated by controlling the position of root joint of the next connectable motion clip arranged in the motion connecting blocks.

In 1110, joint angles may be calculated from the estimated positions of joints to connect the motion clip.

The method for generating dance motion based on the pose and the time inputted by a user has been described in the present invention. The method is suitable for generating dance motions which have constrains such as given poses at a given time and are more dynamic compared to locomotions. The method of the present invention provides motions with higher reality and accuracy since motion capture data is used compared a conventional key-frame method.

The spirit of the present invention has been described by way of example hereinabove, and the embodiments of the present invention may be implemented by using hardware, software or a combination thereof. When they are implemented by software, they may be implemented as software executing in more than one processors using various operating systems or platforms. In addition, the software may be created by using any language among various appropriate programming languages or be compiled in machine language codes or intermediate codes executable in a framework or virtual machine.

In addition, when the exemplary embodiment of the present invention is executed in more than one processors, the exemplary embodiment of the present invention may be implemented by processor readable media such as a memory, a floppy disk, a hard disk, a compact disk (CD), an optical disk or a magnetic tape, or the like in which more than one programs are recorded to conduct the implementation of various exemplary embodiments of the present invention.

What is claimed is:

1. An apparatus for generating dance motion based on timing and pose constraints comprising:
a pose data receiving part configured to receive at least one pose data and time information corresponding to each of the plurality of the pose data from a user;
a similar pose candidate data searching part configured to determine a similar difference value between the received pose data and each pose of the plurality of motion data stored in motion database and select similar pose data of which the similar difference value is equal to or less than a threshold as similar pose candidate data;
a motion clip generating part configured to acquire motion clip candidates, which including pose similar to the received pose data, from the similar pose candidate data based on timing constraints according to the time information;
a connectable motion clip selecting part configured to calculate direction and speed similarity, and relationship similarity of the previous motion clip and the motion clip candidates, calculate the final similarity by providing constant weight values to the similar difference value, the direction and speed similarity and the relationship similarity, and select the connectable motion clip of which the final similarities are equal to or less than a threshold; and
a motion clip connecting part configured to arrange the selected connectable motion clips in motion connecting blocks, estimate positions of joints of next connectable motion clip by controlling position of root joint of the next connectable motion clip, and connect the next connectable motion clip by calculating joint angles from the estimated positions of joints.

2. The apparatus of claim 1, wherein the similar pose candidate data searching part comprises:
a root joint position comparing part configured to generate a difference value (\check{H}) according to height represented by the following Equation 1 based on the received pose data and each of the plurality of pose data stored in the motion database;
\check{H}=(Ryᵢ−Ryⱼ)² Equation 1
a joint pose vector comparing part configured to generate a difference value (\check{V}) according to pose vector represented by the following Equation 2 based on the received pose data and each of the plurality of pose data stored in the motion database; and
$${V}^{} = {\sum }_{k} {ω}_{k} \cdot ( {a}_{1} \cdot {cos}^{- 1} ( {pv}_{i , k} \cdot {pv}_{j , k} ) + {a}_{2} \cdot ( {v}_{i , k} - {v}_{j , k} ) ) \qquad Equation 2$$
a similarity calculating part configured to calculate a similar difference value (\check{P}(Fᵢ,Fⱼ)) represented by the following Equation 3 based on the difference value (\check{H}) according to height and the difference value (\check{V}) according to pose vector and select the similar pose data, of which the similar difference value is equal to or less than a threshold, as similar pose candidate data,
\check{P}(Fᵢ,Fⱼ)=α₁·\check{H}+α₂·\check{V} Equation 3
wherein \check{H} is a difference value according to height, \check{V} is a difference value according to pose vector, Ryᵢ is y-axis position of the root joint, pv_{j,k} is the kth pose vector at the ith frame, α₁,α₂ are importance parameters, ωₖ is importance
$$( {\sum }_{k} {ω}_{k} = 1 )$$
of joint, a₁,a₂ are scale values to control angle difference and length difference of pose vector.

3. The apparatus of claim 1, wherein the connectable motion clip selecting part comprises:
a moving vector identifying part configured to identify if a moving vector of current motion clip fits with a moving vector of one of motion clip candidates by calculating the direction and speed similarity (\check{D}) represented by the following Equation 4 based on the previous motion clip and motion clip candidates;
\check{D}=C₁·COS⁻¹(V_{(i-1,i)}·V_{(j,j+1)})+C₂·(V_{(i-1,i)}−V_{(j,j+1)}) Equation 4
wherein, vector V_{(i-1,i)} is velocity vector by the position of the root joint in i−1th frame and ith frame of previous motion clip, vector V(j, j+1) is velocity vector of following motion clip candidate, C₁,C₂ are scale values to match units of angle and length,
a relationship similarity calculating part configured to convert the positions of the joints of the previous motion clip to a function (\check{f}(xᵢ)) by using the least squares approximation and calculate relationship similarity (\check{C}) represented by the following Equation 5 based on the function (\check{f}(xᵢ)) and positions (pᵢ) of the joints of the one of motion clip candidates; and
$${C}^{} = {\sum }_{i = 1}^{n} {[ \hat{f} ( {x}_{i} ) - {p}_{i} ]}^{2} \qquad Equation 5$$
a connectable motion clip obtaining part configured to provide constant weight values to the similar difference value (\check{P}), the direction and speed similarity (\check{D}), the relationship similarity (\check{C}) and obtain the connectable motion clip of which the final similarities (M) represented by the following Equation 6 are equal to or less than a threshold,
M=μ₁·\check{P}+μ₂·\check{D}+μ₃·\check{C} Equation 6
wherein μ₁,μ₂,μ₃ are weight values.

4. The apparatus of claim 1, wherein the motion clip connecting part comprises:
a similar pose searching part configured to search the similar pose which can be connected in the motion connecting blocks;
a time warping part configured to arrange the connectable motion clips in the motion connecting blocks and perform time warping for empty or overlapping motion connecting blocks among the motion connecting blocks;
a position estimating part configured to control position of root joint of the next connectable motion clip arranged in the motion connecting blocks and estimate positions of joints of the next connectable motion clip by using the Ferguson curve;
a joint angle calculating part configured to calculate joint angles from the estimated positions of joints; and
a character applying part configured to apply the joint angles to a character.

5. A method for generating dance motion based on timing and pose constraints comprising:
receiving at least one pose data and time information corresponding to each of the plurality of the pose data from a user;
determining a similar difference value between the received pose data and each pose of the plurality of motion data stored in motion database and selecting similar pose data of which the similar difference value is equal to or less than a threshold as similar pose candidate data;
acquiring motion clip candidates, which including pose similar to the received pose data, from the similar pose candidate data based on timing constraints according to the time information;
calculating direction and speed similarity and relationship similarity of the previous motion clip and the motion clip candidates, calculating the final similarity by providing constant weight values to the similar difference value, the direction and speed similarity and the relationship similarity, and selecting connectable motion clips of which the final similarities are equal to or less than a threshold; and
arranging the selected connectable motion clips in motion connecting blocks, estimating positions of joints of next connectable motion clip by controlling position of root joint of the next connectable motion clip, and connecting the next connectable motion clip by calculating joint angles from the estimated positions of joints.

6. The method of claim 5, wherein the selecting similar pose data as similar pose candidate data comprises:
generating a difference value (\check{H}) according to height represented by the following Equation 1 based on the received pose data and each of the plurality of pose data stored in the motion database;
\check{H}=(Ryᵢ−Ryⱼ)² Equation 1
generating a difference value (\check{V}) according to pose vector represented by the following Equation 2 based on the received pose data and each of the plurality of pose data stored in the motion database; and
Equation 2
$${V}^{} = {\sum }_{k} {ω}_{k} \cdot ( {a}_{1} \cdot {cos}^{- 1} ( {pv}_{i , k} \cdot {pv}_{j , k} ) + {a}_{2} \cdot ( {v}_{i , k} - {v}_{j , k} ) )$$
calculating a similar difference value (\check{P}(Fᵢ,Fⱼ)) represented by the following Equation 3 based on the difference value (\check{H}) according to height and the difference value (\check{V}) according to pose vector and selecting the similar pose data, of which the similar difference value is equal to or less than a threshold, as similar pose candidate,
\check{P}(Fᵢ,Fⱼ)=α₁·\check{H}+α₂·\check{V} Equation 3
wherein \check{H} is a difference value according to height, \check{V} is a difference value according to pose vector, Ryᵢ is y-axis position of the root joint, pv_{i,k} is the kth pose vector at the ith frame, α₁,α₂ are importance parameters, ωₖ is importance
$$( {\sum }_{k} {ω}_{k} = 1 )$$
of joint, a₁,a₂ are scale values to control angle difference and length difference of pose vector.

7. The method of claim 5, wherein the selecting the connectable motion clips comprises:
identifying if a moving vector of current motion clip fits with a moving vector of one of motion clip candidates by calculating the direction and speed similarity (\check{D}) represented by the following Equation 4 based on the previous motion clip and motion clip candidates;
\check{D}=C₁·COS⁻¹(V_{(i-1,i)}·V_{(j,j+1)})+C₂·(V_{(i-1,i)}−V_{(j,j+1)}) Equation 4
wherein, vector V_{(i-1,i)} is velocity vector by the position of the root joint in i−1th frame and ith frame of previous motion clip, vector V(j, j+1) is velocity vector of following motion clip candidate, C₁,C₂ are scale values to match units of angle and length,
converting the positions of the joints of the previous motion clip to a function (\check{f}(xᵢ) by using the least squares approximation and calculating relationship similarity (\check{C}) represented by the following Equation 5 based on the function (\check{f}(xᵢ)) and positions (pᵢ) of the joints of the one of motion clip candidates; and
$${C}^{} = {\sum }_{i = 1}^{n} {[ \hat{f} ( {x}_{i} ) - {p}_{i} ]}^{2} \qquad Equation 5$$
providing constant weight values to the similar difference value (\check{P}), the direction and speed similarity (\check{D}), the relationship similarity (\check{C}) and obtaining the connectable motion clip of which the final similarities (M) represented by the following Equation 6 are equal to or less than a threshold,
M=μ₁·\check{P}+μ₂·\check{D}+μ₃·\check{C} Equation 6
wherein μ₁,μ₂,μ₃ are weight values.

8. The method of claim 5, wherein the connecting the next connectable motion clip comprises:
searching the similar pose which can be connected in the motion connecting blocks;
arranging the connectable motion clips in the motion connecting blocks and performing time warping for empty or overlapping motion connecting blocks among the motion connecting blocks;
controlling position of root joint of the next connectable motion clip arranged in the motion connecting blocks and estimating positions of joints of the next connectable motion clip by using the Ferguson curve;
calculating joint angles from the estimated positions of joints; and
applying the joint angles to a character.
